(19) United States
(12) Patent Application Publication
(10) Pub. No.: US 2002/0170382 A1
(43) Pub. Date: Nov. 21, 2002

(54) Safety cycle pedal

(76) Inventor: Ta Hsin Yang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,606

(22) Filed: May 17, 2001

(51) Int. Cl. B62M 3/08

(52) U.S. Cl. 74/594.6

(57) ABSTRACT

A safety cycle pedal includes a pedal body with an axle rotatably extending therethrough and two frames are respectively connected to two opposite surfaces of the pedal body by two respective pins. Each frame has end plate through which a bolt extends therethrough. Two torsion springs are mounted on the two pins and each of which is shaped to include two legs and a connection portion which is connected between the two legs. The two connection portions respectively extend from the two opposite surfaces of the pedal body. Two bars are respectively connected to the two bolts and located between the two lugs of the two respective frames. The two bars respectively contact the two legs of the two respective torsion springs.

### FIELD OF THE INVENTION

The present invention relates to a safety cycle pedal and each surface of the pedal has a fastener and a stop, and the clamping force of the fastener can be adjusted.

### BACKGROUND OF THE INVENTION

A conventional safety cycle pedal is shown in FIG. 7 and generally includes a body 60 of the pedal with an axle 62 rotatably extending through the body 60 and the axle 62 is connected with the crank of the bicycle. Two positioning members 63 are respectively mounted to two surfaces of the body 60 and two clamp members 64 are respectively connected to two ends of the body 60. Each of the two clamp members 64 is cooperated with two torsion springs 642 so that each clamp member 64 has a first end being pushed toward the axle 62. One end of a wedge of a cycling shoe can be clamped by the first end of one of the two clamp members and the other end of the wedge is stopped by a second end of the other clamp member. This conventional safety cycle pedal has a complicated structure and has a high cost. FIGS. 8 and 9 show another conventional safety cycle pedal which has a fixed stop 72 and a fastener 73 on a surface of the pedal 70 and the wedge of cycling shoe 50 pushes the fastener 73 by one end of the wedge and then engaging the other end of the wedge with the stop 72. Because only one surface of the pedal has the fastener 73 and the stop 72, so that the user has to carefully to check which surface of the pedal 70 is facing up so as to engage the wedge with the fastener 73 and the stop 72. In addition, only the fastener 73 is movable so that the fastener 73 is operated in each engagement with the wedge 50 and this makes the torsion spring connected to the fastener 73 tend to be overworked within a short period of time.

### SUMMARY OF THE INVENTION

In accordance with one aspect of the present invention, there is provided a safety cycle pedal and comprises a pedal body having an axle rotatably extending therethrough and two openings are defined in the pedal body. Two frames each have two lugs on a first end thereof and an end plate extends from a second end of each of the frames. Two bolts respectively extend through the two end plates and are respectively connected to two bars. The two frames are respectively engaged with the two openings from two opposite surfaces of the pedal body and two pins respectively extend through the pedal body and the two lugs of the two frames in the two openings. Two torsion springs are mounted on the two pins and each of the torsion springs is shaped to includes two legs and a connection portion which is connected between the two legs. The two respective connection portions of the two torsion springs respectively extend from the two opposite surfaces of the pedal body. The two bars respectively contact the two legs of the two respective torsion springs.

The primary object of the present invention is to provide a safety cycle pedal wherein the force of the two torsion springs can be adjusted.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the safety cycle pedal of the present invention;

FIG. 2 is an exploded view to show the safety cycle pedal of the present invention;

FIG. 3 is a plan view to show the safety cycle pedal of the present invention;

FIG. 4 shows a wedge on a cycling shoe is to be engaged with the safety cycle pedal of the present invention;

FIG. 5 shows a wedge on a cycling shoe is engaged with the safety cycle pedal of the present invention;

FIG. 6 is a plan view to show that the wedge of the cycling shoe is engaged with the safety cycle pedal of the present invention;

FIG. 7 is an exploded view to show a first embodiment of the conventional safety cycle pedal;

FIG. 8 is a cross sectional view to show a wedge of a cycling shoe is engaged with a second embodiment of the conventional safety cycle pedal, and

FIG. 9 is a perspective view to show the second embodiment of the conventional safety cycle pedal.

### DETAILED DESCRIPTION OF THE PREFERRED EMBODIMENT

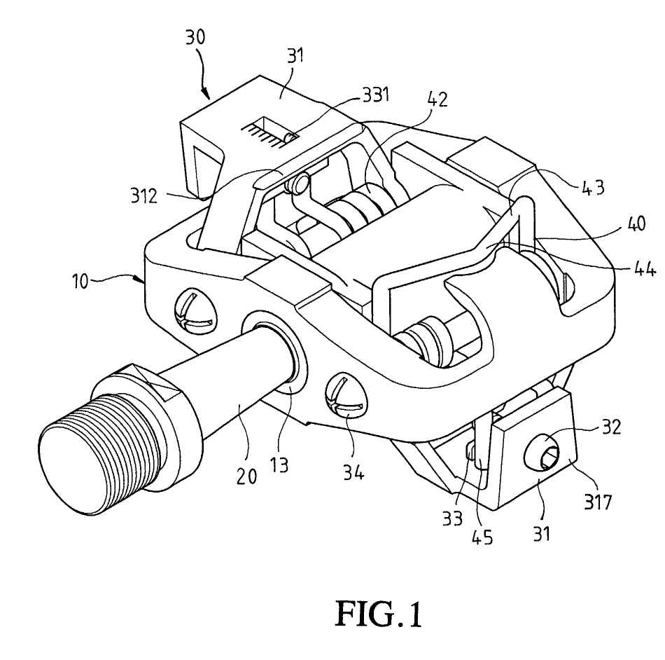

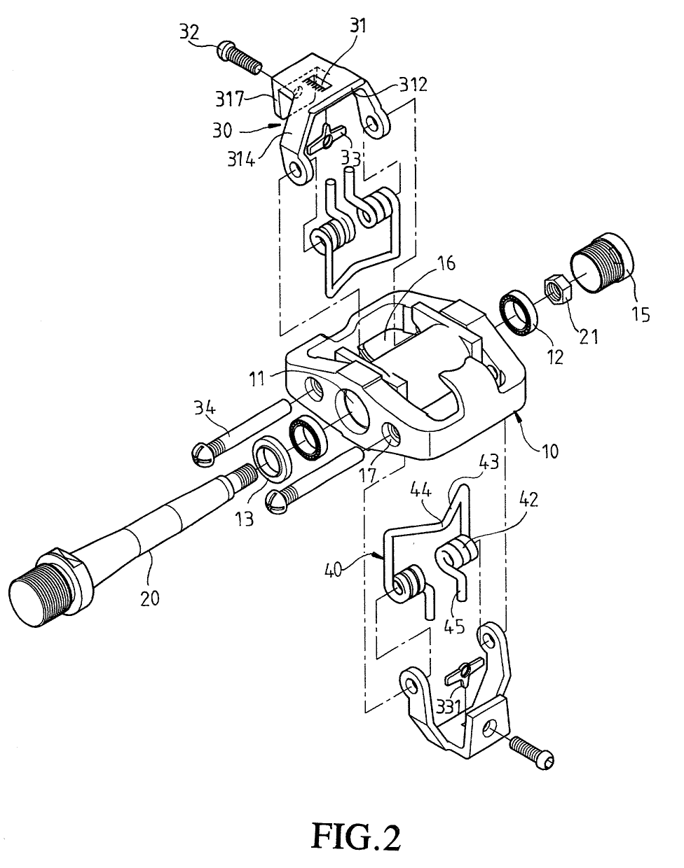

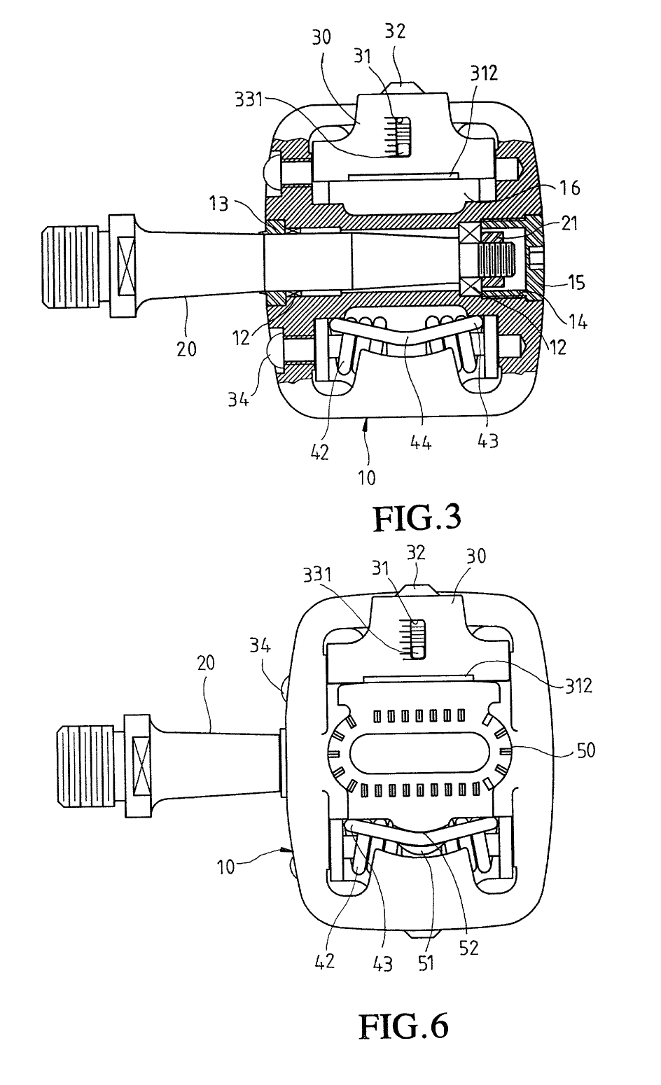

Referring to FIGS. 1 to 3, the safety cycle pedal of the present invention comprises a pedal body 10 having an axle 20 rotatably extending through a passage 11 in the pedal body 10 with two bearings 12 being mounted on the axle 20. The axle 20 has a threaded section to be engaged with a nut 21 and cooperated with a end cap 15. A dust cap 13 is engaged with the passage 11 to prevent dust from entering the passage 11. Two openings 16 are defined in the pedal body 10 and the axle 20 is located between the two openings 16. Two pins 34 respectively extend into the pedal body 10 via two holes 17 and are located in the two openings 16.

Two frames 30 each have two lugs 314 extending from a first end thereof and an end plate 317 extends from a second end of each of the frames 30. Two bolts 32 respectively extend through the two end plates 317 and extend in the two openings 16. The two frames 30 are respectively engaged with the two openings 16 from two opposite surfaces of the pedal body 10 and the two pins 34 extend through the two lugs 314 of the two frames 30 in the two openings 16.

Two torsion springs 40 each are shaped as an M-shape and includes two legs 45 and a connection portion 43 which is connected between the two legs 45. Each of the legs 45 is connected to a coil portion 42 so that the pin 34 respectively extend through the coil portions 42 of the torsion springs 40. The two respective connection portions 43 of the two torsion springs 40 respectively extend from the two opposite surfaces of the pedal body 10 and each of which includes a bent portion 44. Each of the two frames 30 has a slot 31 defined therethrough and index marks are marked on the top of the frames 30 so as to show the spring force of the torsion spring 40.

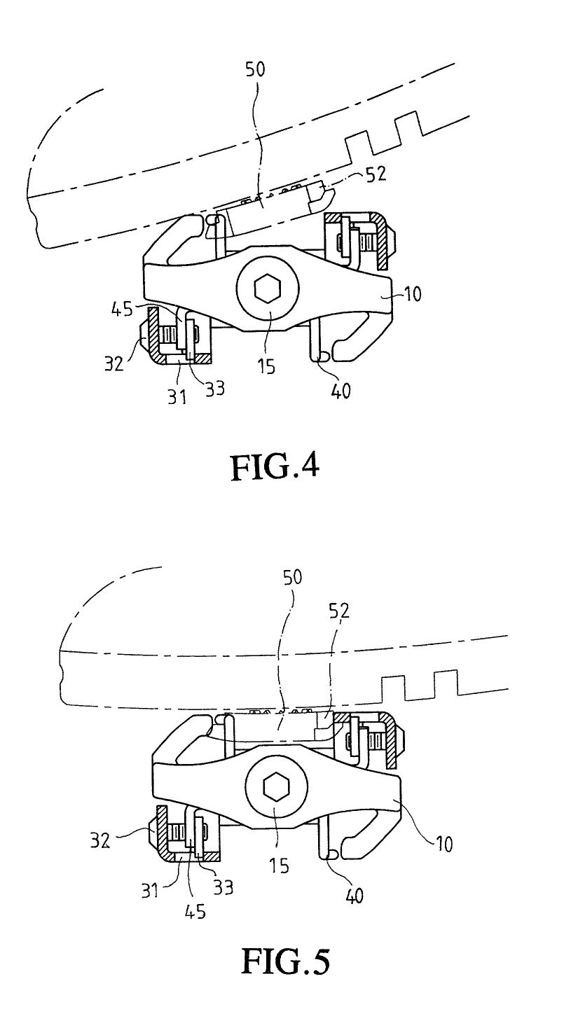

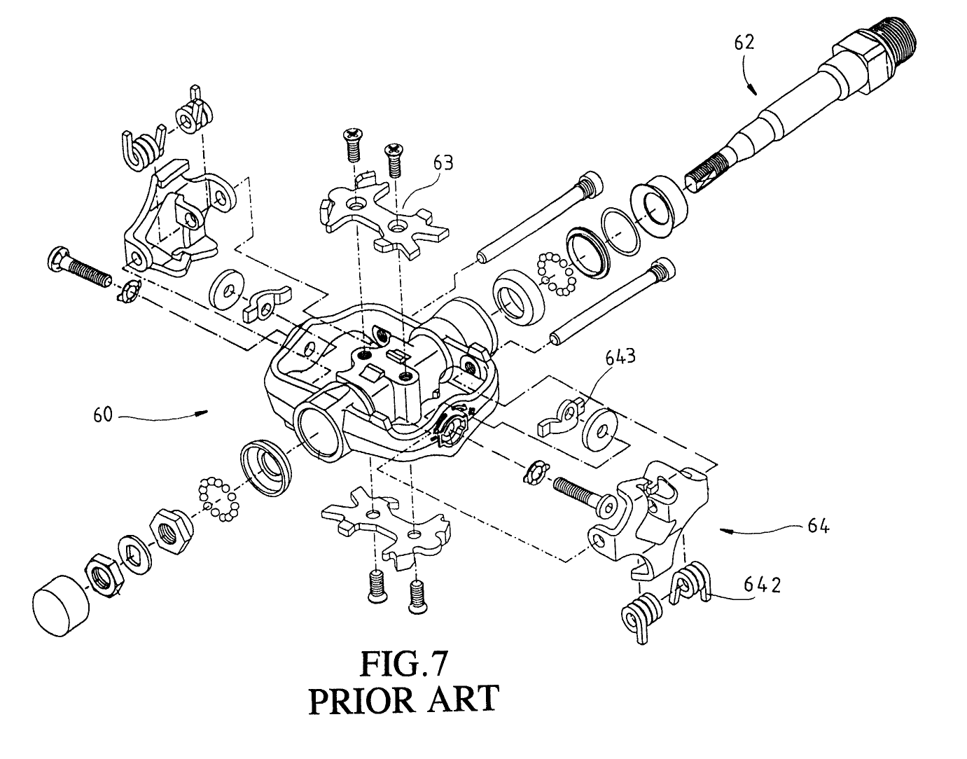

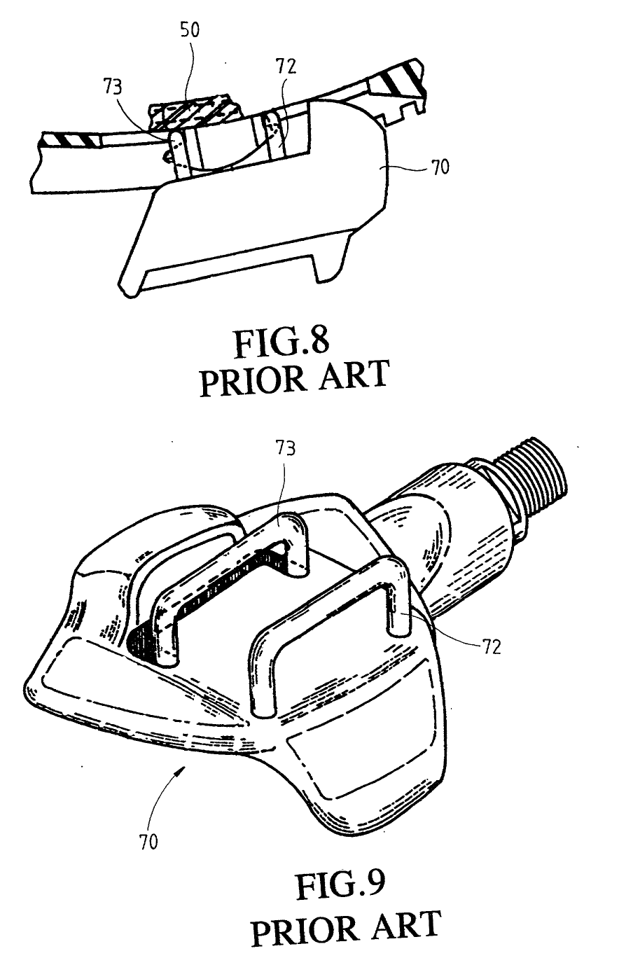

Two T-shaped bars 33 each have a hole for being connected to respective one of the two bolts 32 and the two bars 33 are located between the two lugs 314 of the two respective frames 30. The two bars 33 respectively contact the two legs 45 of the two torsion springs 40 so as to maintain a desired torque of the torsion springs 40. Each of the bars 33 has a protrusion 331 which is movably retained in the slot 31 so that the user can align the protrusion 331 with the index marks on the top of the frames 30 to know the torque that the torsion springs 40 apply on a wedge 50 of a cycling shoe as shown in FIG. 4 or FIG. 5.

As shown in FIGS. 4 to 6, each of the connection portions 43 of the two torsion springs 40 includes a bent portion 44 so as to engage with the wedge 50. One end of the wedge 50 firstly engages with the bent portion 44 of the torsion spring 40 and the other end of the wedge 50 then slides downward on an inclined surface 312 defined in the second end of the frame 30 so as to let a step portion 52 on the wedge 50 be engaged with the second end of the frame 30.

The torque applied on the wedge 50 can be adjusted by moving the bolts 32 which move the two bars 32 to push the two legs 45 of the torsion springs 40 so that the torque applied on the wedges 50 are adjusted.

While we have shown and described the embodiment in accordance with the present invention, it should be clear to those skilled in the art that further embodiments may be made without departing from the scope of the present invention.

What is claimed is:

1. A safety cycle pedal comprising:
a pedal body having an axle rotatably extending therethrough, two openings defined in said pedal body and said axle located between said two openings;
two frames each having two lugs extending from a first end thereof and an end plate extending from a second end of each of said frames, two bolts respectively extending through said two end plates, said two frames respectively engaged with said two openings from two opposite surfaces of said pedal body and two pins respectively extending through said pedal body and said two lugs of said two frames, two torsion springs mounted on said two pins and each of said torsion springs being shaped to includes two legs and a connection portion which is connected between said two legs, said two respective connection portions of said two torsion springs respectively extending from said two opposite surfaces of said pedal body, and
two bars respectively connected to said two bolts and located between said two lugs of said two respective frames, said two bars respectively contacting said two legs of said two torsion springs.

2. The safety cycle pedal as claimed in claim 1, wherein each of said two frames has a slot defined therethrough and each of said bars has a protrusion movably retained in said slot.

3. The safety cycle pedal as claimed in claim 1, wherein each of said connection portions of said two torsion springs includes a bent portion.

4. The safety cycle pedal as claimed in claim 1 further comprising an inclined surface defined in said second end of each of said two frames.
